(19) United States
(12) Patent Application Publication
(10) Pub. No.: US 2004/0090774 A1
(43) Pub. Date: May 13, 2004

(54) Miniature light

(76) Inventor: Chih-Yuan Hsueh, Taipei (TW)

Correspondence Address: BIRCH STEWART KOLASCH & BIRCH, PO BOX 747, FALLS CHURCH, VA, 22040-0747, US

(21) Appl. No.: 10/290,307

(22) Filed: Nov. 8, 2002

(51) Int. Cl. F21L 4/00

(52) U.S. Cl. 362/183; 362/276; 362/802

(57) ABSTRACT

A miniature light includes at least a light-emitting unit, a light-induction unit adapted to control the on and off of the light-emitting unit according to an intensity of ambient light, an uninterruptible power supply module adapted to continuously supply power to the light-emitting unit in a power interruption, and a switch unit allowing a user to set the miniature light to a desired operating mode, so that the miniature light is able to automatically emit light in a dark or dim environment or in a power interruption.

### BACKGROUND OF THE INVENTION

The present invention relates to a miniature light, and more particularly to a miniature light capable of automatically emitting light in a dark or dim environment or in a power interruption, so as to achieve the effect of automatic turning on/off and emergency lighting.

The densely erected high-rise buildings provide largely increased residential spaces for people living in metropolitan areas. However, these densely distributed high-rise buildings also block sunshine and moonlight and have poor ambient light that degrades people's living quality in these buildings and reduces people's moving ability. Fortunately, various types of lighting fixtures are available to helpfully solve the problem of poor ambient light encountered by most people living in the high-rise buildings.

On the other hand, most people prefer to sleep or to take a rest in an environment in which possible interferences from noises and light are minimized. For example, most people would turn off the lights before going to bed to avoid light stimulation to the eyes. However, to avoid inconveniences possibly caused to people by a complete dark ambient environment in the house, particularly when people have to move or do something in the dark, miniature lights are often mounted on the walls of bedrooms, passageways and staircases. Conventional miniature lights usually include a small yellow bulb to emit soft light that does not stimulate people's eyes but is sufficient for people to see in a dim environment.

The above-mentioned miniature light must be plugged to a receptacle and turned on for it to work. In the event a user does not plug the miniature light to a receptacle or turn it on before going to bed, he or she might have to inconveniently and dangerously plug or turn on the miniature light in the dark when necessary. Moreover, the miniature light becomes completely useless in a power interruption caused by any reason, and accidents might occur in this condition, particularly when there is not any emergency light available for use. As a matter of fact, emergency lights are expensive and not always mounted in every building in the staircases.

Therefore, it is desirable to develop a miniature light that is not expensive and can automatically emit light in a dark or dim environment and in a power interruption to provide people with more conveniences and enhanced safety in their living space.

### SUMMARY OF THE INVENTION

A primary object of the present invention is to provide a miniature light that automatically emits light in a dark or dim environment and in a power interruption.

Another object of the present invention is to provide a miniature light that can be used indoors and outdoors as a flashlight.

To achieve the above and other objects, the miniature light of the present invention includes at least a light-emitting unit, a light-induction unit adapted to control the on and off of the light-emitting unit according to an intensity of ambient light, an uninterruptible power supply module adapted to continuously supply power to the light-emitting unit in a power interruption, and a switch unit allowing a user to set the miniature light to a desired operating mode, so that the miniature light is able to automatically emit light in a dark or dim environment and in a power interruption.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a miniature light according to an embodiment of the present invention;

FIG. 2 is a circuit diagram for the miniature light of the present invention;

FIG. 3 is a block diagram of the miniature light of the present invention;

FIG. 4 shows a first example of use of the miniature light of the present invention;

FIG. 5 shows a second example of use of the miniature light of the present invention;

FIG. 6 shows a third example of use of the miniature light of the present invention;

FIG. 7 shows a fourth example of use of the miniature light of the present invention; and

FIG. 8 shows a fifth example of use of the miniature light of the present invention;

### DETAILED DESCRIPTION OF THE PREFERRED EMBODIMENTS

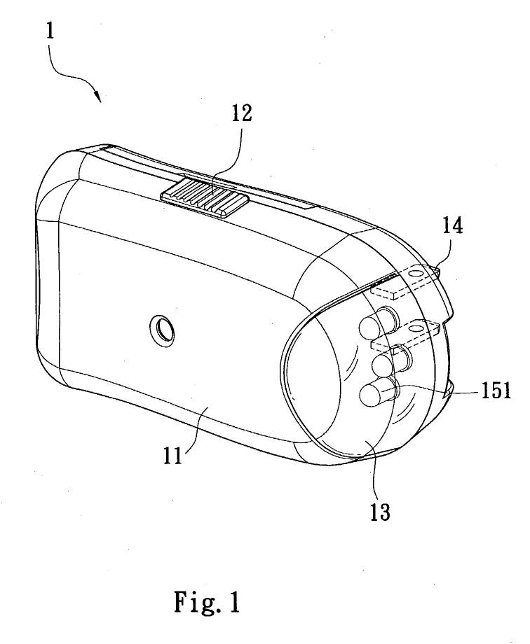

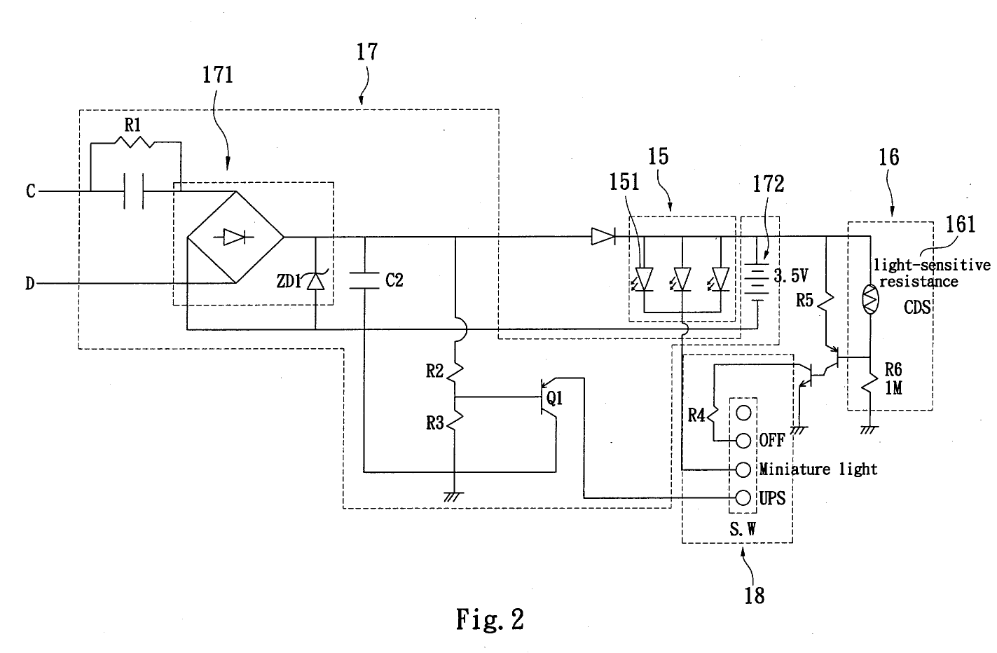

Please refer to FIGS. 1, 2, and 3 that are sequentially a perspective view, a circuit diagram, and a block diagram of a miniature light according to an embodiment of the present invention. As shown, the miniature light 1 includes a shell 11, in which a circuit board (not shown) is mounted, a slide switch 12 provided at one side of the shell 11 to be pushed with a finger, a transparent hood 13 provided on a surface of the shell 11 at a selected area for light emitted from a light-emitting unit on the circuit board to project out of the miniature light 1 via the hood, and a plug 14 provided at a rear side of the shell 11 for connecting to a public power source and thereby supplying power to the circuit board.

On the circuit board, there is provided at least a light-emitting unit 15, a light-induction unit 16, an uninterruptible power supply module 17, and a switch unit 18.

The light-emitting unit 15 includes more than one light-emitting diode (LED) 151. However, the light-emitting unit 15 is not necessarily limited to the light-emitting diodes 151, and it may include small bulbs or other light emitting means.

The light-induction unit 16 mainly includes a light-sensitive resistance 161 as a drive element thereof. It is adapted to control the on and off of the light-emitting unit 15 according to an intensity of ambient light sensed by it.

The uninterruptible power supply module 17 includes a rectification unit 171 for rectifying an AC input voltage to a DC output voltage, and a charging battery 172 that can be charged with the DC output voltage. When the charging battery 172 is charging, it is disconnected from the light-emitting unit 15 and does not supply power to the latter. And when the AC input power supply is interrupted, the charging battery 172 immediately stops charging and continuously supplies power to the light-emitting unit 15 for the miniature light 1 to function like an emergency light.

The switch unit 18 includes three contacts to enable setting of the miniature light 1 to one of three different modes, namely, OFF, MINIATURE LIGHT, and UPS (Uninterruptible Power Supply) modes. The switch unit 18 is electrically connected to the slide switch 12. By pushing the slide switch 12 to different positions, a user may select to set the miniature light 1 to the MINIATURE LIGHT (light-induction) mode or the UPS (emergency light) mode.

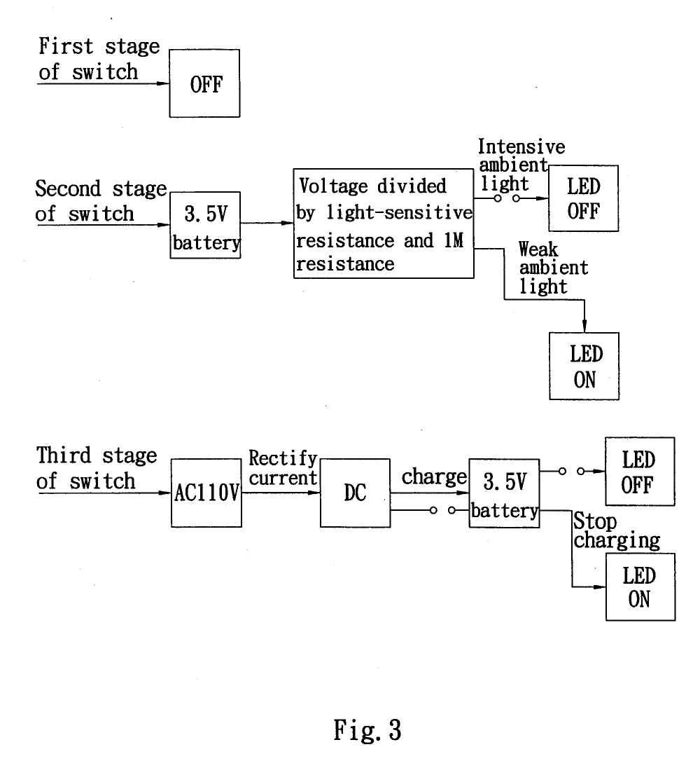

Please refer to FIG. 3. When the slide switch 12 is set to a first stage thereof or the OFF mode, the miniature light 1 does not act at all. When the slide switch 12 is set to a second stage thereof or the light-induction mode, a voltage of the charging battery 172 is divided by the light-sensitive resistance 161 and a 1M resistance. Whereby, the LED's 151 do not emit light when there is an intensive light source, and emit light when there is a weak light source. And, when the slide switch 12 is set to a third stage thereof or the UPS mode, the miniature light 1 is adapted to rectify the alternating current of 110V input via the plug 14 to a direct current and charges the charging battery 172 with the direct current. At this point, the LED's 151 do not emit light. However, when the input AC power supply is disconnected, the charging battery 172 immediately stops charging and continuously supplies power to the LED's 151 for them to emit light.

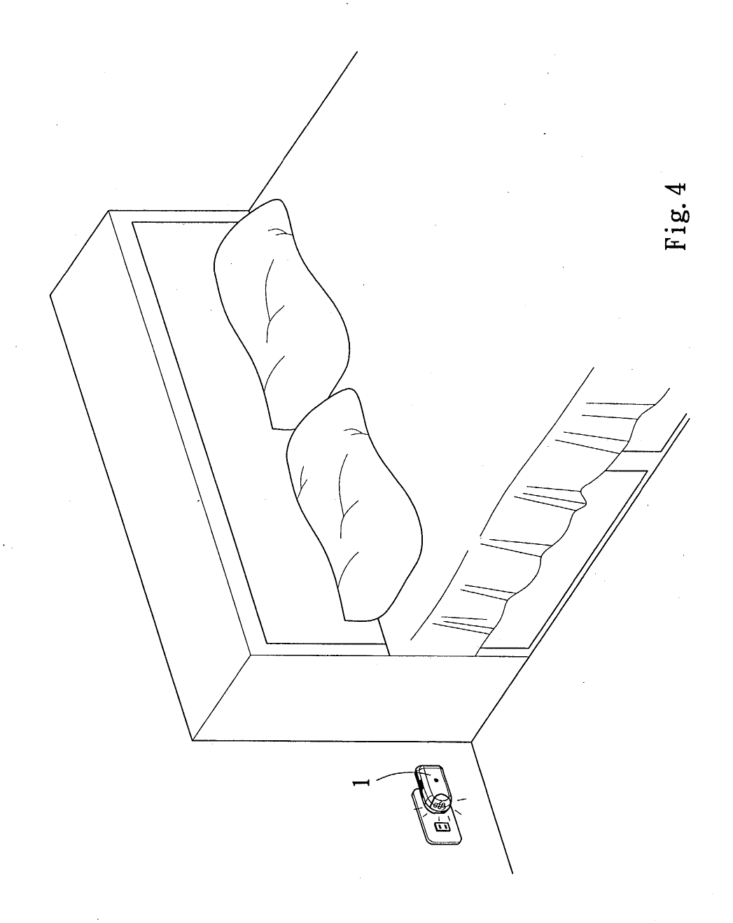

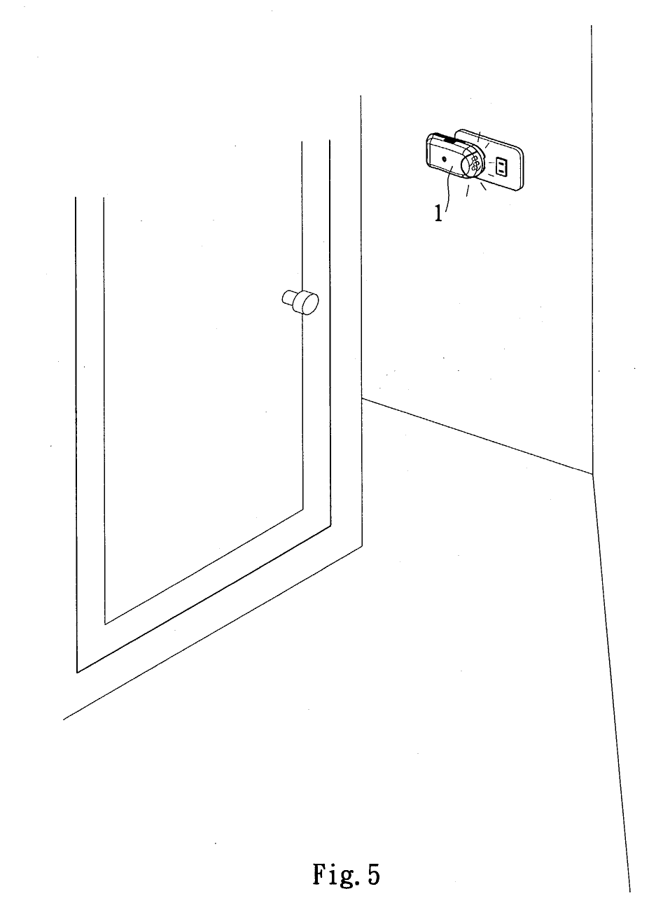

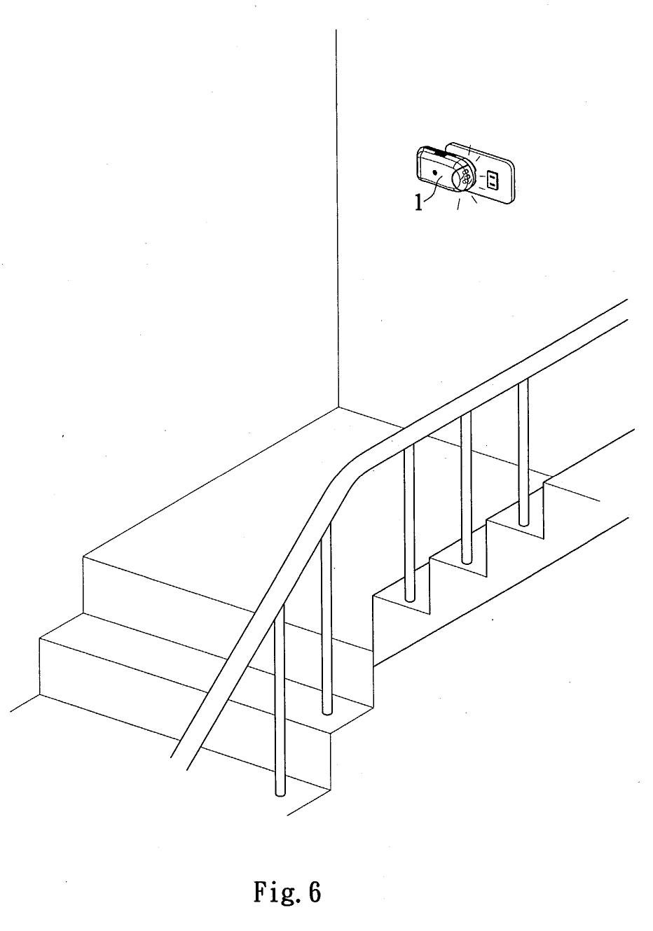

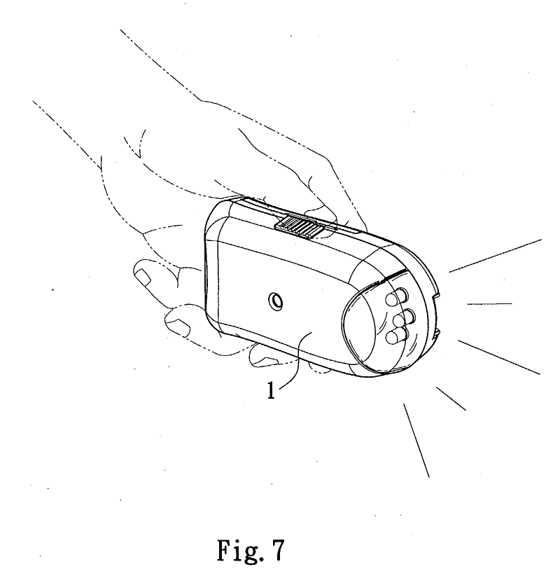

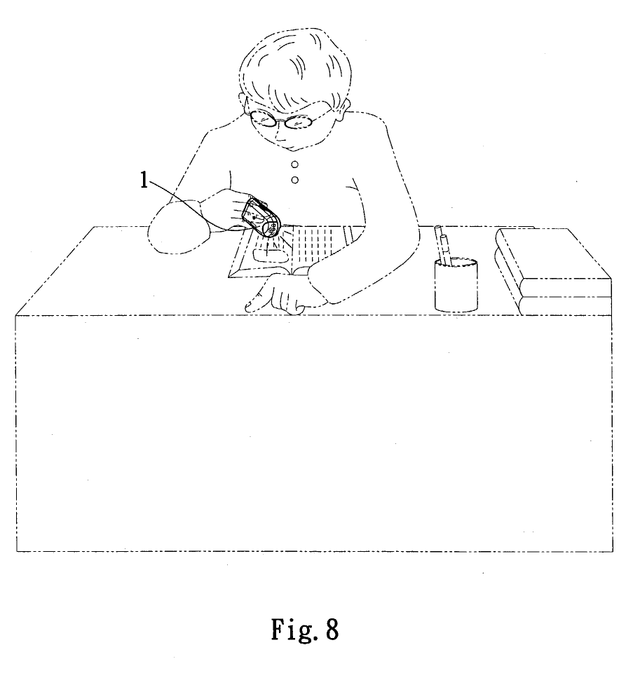

The miniature light 1 is very suitable for mounting in a bedroom, near a bathroom door, and on the wall of a stairway, as shown in FIGS. 4, 5, and 6, respectively, and setting to the second or the third mode for it to automatically emit light when an ambient light is weak or when there is a power failure. Alternatively, the miniature light 1 may be held with one hand for use indoors or outdoors to function like a flashlight in an emergency, as shown in FIG. 7. The miniature light 1 may also be used in a power interruption as a temporary table lamp to provide the user a reading environment in the dark, as shown in FIG. 8.

With the above arrangements, the miniature light 1 of the present invention is able to automatically emit light in a dark or dim environment or in a power interruption. It is no need to manually turn on the miniature light 1 while the same can function like an emergency light.

What is claimed is:

1. A miniature light, comprising a light-emitting unit, a light-induction unit, an uninterruptible power supply module, and a switch unit; said light-induction unit being adapted to control the on and off of said light-emitting unit according to an intensity of ambient light sensed by it; said uninterruptible power supply module being adapted to continuously supply power to said light-emitting unit in a power interruption; and said switch unit allowing setting of said miniature light to one of many operating modes thereof; whereby said miniature light is able to automatically emit light in a dark or dim environment as an automatically turned on light or in a power interruption as an emergency light.

2. The miniature light as claimed in claim 1, wherein said light-emitting unit includes more than one light emitting diode.

3. The miniature light as claimed in claim 1, wherein said light-emitting unit includes more than one bulb.

4. The miniature light as claimed in claim 1, wherein said light-induction unit includes a light-sensitive resistance as a driving element thereof.

5. The miniature light as claimed in claim 1, wherein said uninterruptible power supply module includes a rectification unit and a charging battery, and is adapted to rectify an AC input voltage via said rectification unit to a DC output voltage for charging said charging battery; said charging battery being disconnected from and stopping supplying power to said light-emitting unit when it is being charged, and said charging battery immediately stopping charging and continuously supplying power to said light-emitting unit when it is disconnected from an AC power source, such that said miniature functions like an emergency light.

6. The miniature light as claimed in claim 1, wherein said switch unit includes a slide switch, pushing of which to predetermined positions allowing said miniature light to be set to a light-induction mode, in which said miniature light automatically emits light in a dark or dim environment, or to an emergency light mode, in which said miniature light automatically emits light in a power interruption.
